(19) United States
(12) Patent Application Publication
(10) Pub. No.: US 2026/0364668 A1
(43) Pub. Date: Nov. 19, 2026

(54) ELECTRIC-HYDRAULIC INTEGRATED DRIVE SYSTEM AND CONTROL METHOD FOR LARGE-SCALE FORGING MANIPULATORS

(71) Applicant: TAIYUAN UNIVERSITY OF TECHNOLOGY, Taiyuan City (CN)

(72) Inventors: Zhixin YAN, Taiyuan City (CN); Zhijie PAN, Taiyuan City (CN); Long QUAN, Taiyuan City (CN); Yuxin YANG, Taiyuan City (CN); Shuofeng ZHANG, Taiyuan City (CN)

(21) Appl. No.: 19/359,651

(22) Filed: Oct. 15, 2025

(30) Foreign Application Priority Data
May 15, 2025 (CN) 202510622705.5

(51) Int. Cl. B21J 13/10

(52) U.S. Cl. CPC B21J 13/10

(57) ABSTRACT

An electric-hydraulic integrated drive system and a control method for large-scale forging manipulators are provided, including: an electrical drive unit, a hydraulic power unit, a front offset unit, a rear offset unit, a tilting unit, a lifting unit, and a traveling unit; the electrical drive unit is connected to an external power grid on one hand, and is respectively connected to motors of the hydraulic power unit, the front offset unit, the rear offset unit, the tilting unit, the lifting unit and the traveling unit on the other hand; and the hydraulic power unit is respectively connected to control valve groups of the front offset unit, the rear offset unit, the tilting unit, the lifting unit, and the traveling unit. Motion is controlled by electric motors while power is provided by hydraulic systems.

### CROSS-REFERENCE TO RELATED APPLICATIONS

This application claims priority to Chinese Patent Application No. 202510622705.5, filed on May 15, 2025, the contents of which are hereby incorporated by reference.

### TECHNICAL FIELD

The disclosure belongs to the technical field of driving and transmission for forging manipulators, and in particular relates to an electric-hydraulic integrated drive system and a control method for large-scale forging manipulators.

### BACKGROUND

Hydraulic and electromechanical systems, as two main driving and transmission schemes, exist in both linear and rotational forms, and they are widely used in various fields such as aerospace, marine vessels, national defense and military industry, mining and metallurgy, construction machinery, as well as agricultural and forestry machinery. These two types of transmission methods have their own characteristics: hydraulic transmission is favored for its high power density, large load-carrying capacity, and excellent impact resistance. The traditional valve-controlled hydraulic system is widely used due to its simple structure and mature technology, but it relies on throttling for speed and position control, resulting in large throttling losses and low system energy efficiency. Although the pump-controlled hydraulic system improves efficiency by eliminating throttling losses, high-power systems have obvious shortcomings in dynamic response, installed power, and cost. In contrast, the electromechanical transmission system has the advantages of high transmission efficiency, good control performance, and lower maintenance cost. However, its load-carrying capacity is relatively weak, its impact resistance is insufficient, and it still faces challenges of slow dynamic response, large installed power, and high cost in high-power applications.

Existing large-scale forging manipulators generally adopt fully hydraulic drive and control systems, which not only need to overcome external loads but also precisely control motion. However, the current technology may only control one dimension of position/speed or force in linear systems, and only one dimension of angular position/speed or torque in rotational systems. These limitations prevent existing large-scale forging manipulator systems from simultaneously meeting the comprehensive requirements of maximum load, positioning accuracy, and response speed, making it difficult to achieve high power density, high energy efficiency and high performance.

The existing patent “Position-Pressure Control Method for Hydraulic Cylinder Positioning of Large-Scale Forging Manipulators” discloses adding a position control mode to the force control mode, initially realizing the control over hydraulic cylinder height, speed, and control accuracy, but force and position still may not be controlled simultaneously, and the effect is still not ideal. The existing patent “Displacement-Force Composite Control Lifting System for Forging Manipulators” discloses adding a force control mode to the position control mode and selecting the mode according to working conditions, but it is still difficult to realize both precise displacement control and high compliance simultaneously under specific working conditions. Although the use of high-frequency response proportional servo valves improves the response speed, the cost is high. Although these patents have made attempts in control technology, they have not effectively solved the problem of simultaneous control of position and force, and the control system is relatively complex.

Therefore, there is an urgent need to propose an electrical-hydraulic integrated drive system and a control method for large-scale forging manipulators to solve the problems existing in the prior art.

### SUMMARY

To solve the above technical problems, the disclosure proposes an electric-hydraulic integrated drive system and a control method for large-scale forging manipulators to solve the problems existing in the prior art.

To achieve the above purpose, the disclosure provides an electric-hydraulic integrated drive system for large-scale forging manipulators, including: an electrical drive unit, a hydraulic power unit, a front offset unit, a rear offset unit, a tilting unit, a lifting unit, and a traveling unit;
the electrical drive unit is connected to an external power grid on one hand, and is respectively connected to motors of the hydraulic power unit, the front offset unit, the rear offset unit, the tilting unit, the lifting unit, and the traveling unit on the other hand;
the hydraulic power unit is respectively connected to control valve groups of the front offset unit, the rear offset unit, the tilting unit, the lifting unit, and the traveling unit.

The hydraulic power unit includes a high-pressure accumulator, a medium-pressure accumulator, an oil tank, and an oil supplement module; where the high-pressure accumulator and the medium-pressure accumulator are respectively connected to the oil supplement module.

Optionally, the front offset unit includes a first front offset actuator, a second front offset actuator, and a front offset unit control valve group; where the first front offset actuator and the second front offset actuator are arranged symmetrically; one end of the first front offset actuator and the second front offset actuator is installed on a front swing arm, and another end is connected to a suspension rod; a motor of the first front offset actuator is connected to the electrical drive unit, and a motor of the second front offset actuator is connected to the electrical drive unit; a first connection port a, a second connection port b, and a third connection port c of the front offset unit control valve group are respectively connected to the high-pressure accumulator, the medium-pressure accumulator, and the oil tank; and a fourth connection port d and a fifth connection port e of the front offset unit control valve group are respectively connected to a rodless chamber of the first front offset actuator, a rod chamber of the second front offset actuator, a rod chamber of the first front offset actuator, and a rodless chamber of the second front offset actuator;
the rear offset unit includes a first rear offset actuator, a second rear offset actuator, and a rear offset unit control valve group; where the first rear offset actuator and the second rear offset actuator are arranged symmetrically; one end of the first rear offset actuator and the second rear offset actuator is installed on a rear swing arm, and another end is connected to a tilting unit actuator; a motor of the first rear offset actuator is connected to the electrical drive unit, and a motor of the second rear offset actuator is connected to the electrical drive unit; a first connection port a, a second connection port b, and a third connection port c of the rear offset unit control valve group are respectively connected to the high-pressure accumulator, the medium-pressure accumulator and, the oil tank; and a fourth connection port d and a fifth connection port e of the rear offset unit control valve group are respectively connected to a rodless chamber of the first rear offset actuator, a rod chamber of the second rear offset actuator, a rod chamber of the first rear offset actuator, and a rodless chamber of the second rear offset actuator;
the tilting unit includes a tilting actuator and a tilting unit control valve group; where one end of the tilting actuator is connected to a rear offset unit actuator, and another end is connected to a clamp frame; the motor of the tilting actuator is connected to the electrical drive unit; a first connection port a, a second connection port b, and a third connection port c of the tilting unit control valve group are respectively connected to the high-pressure accumulator, the medium-pressure accumulator, and the oil tank; and a fourth connection port d and a fifth connection port e of the tilting unit control valve group are respectively connected to a rodless chamber, and a rod chamber of the tilting actuator;
the lifting unit includes a first lifting actuator, a second lifting actuator, and a lifting unit control valve group; the first lifting actuator and the second lifting actuator are arranged symmetrically; one end of the first lifting actuator and the second lifting actuator is installed on a cart, and another end is connected to the front swing arm; a motor of the first lifting actuator is connected to the electrical drive unit, and a motor of the second lifting actuator is connected to the electrical drive unit; a first connection port a, a second connection port b, and a third connection port c of the lifting unit control valve group are respectively connected to the high-pressure accumulator, the medium-pressure accumulator, and the oil tank; and a fourth connection port d and a fifth connection port e of the lifting unit control valve group are respectively connected to a rod chamber of the first lifting actuator, a rod chamber of the second lifting actuator, a rodless chamber of the first lifting actuator, and a rodless chamber of the second lifting actuator; and
the traveling unit includes a traveling drive motor, a first traveling hydraulic motor, a second traveling hydraulic motor, and a traveling unit control valve group; the traveling unit is installed on the cart and connected to wheels; the traveling drive motor is connected to the electrical drive unit; a first connection port a, a second connection port b, and a third connection port c of the traveling unit control valve group are respectively connected to the high-pressure accumulator, the medium-pressure accumulator, and the oil tank; and a fourth connection port d and a fifth connection port e of the traveling unit control valve group are respectively connected to an inlet of the first traveling hydraulic motor, an inlet of the second traveling hydraulic motor, an outlet of the first traveling hydraulic motor, and an outlet of the second traveling hydraulic motor.

Optionally, the traveling unit selects any one form of front-wheel drive, rear-wheel drive and front-rear wheel common drive according to actual requirements; and a drive form of each wheel is traveling drive motor drive, traveling hydraulic motor drive or common drive of traveling drive motor and traveling hydraulic motor;
the drive form of the traveling drive motor and traveling hydraulic motor for the traveling unit adopts any one form of coaxial series connection, multi-axis parallel connection or coaxial integration; and
the numbers of the traveling drive motors and the traveling hydraulic motors are configured according to actual requirements.

Optionally, the first front offset actuator, the second front offset actuator, the first rear offset actuator, the second rear offset actuator, the tilting actuator, the first lifting actuator, and the second lifting actuator all include a lead screw drive motor, a reducer, a lead screw pair, a seal, a cylinder block, and a piston rod;
the lead screw drive motor converts rotational motion into linear motion of the piston rod sequentially through the reducer and the lead screw pair;
the hydraulic power unit drives the piston rod to perform linear motion through the control valve group.

Optionally, the front offset unit control valve group, the rear offset unit control valve group, the tilting unit control valve group, the lifting unit control valve group and the traveling unit control valve group all include a first control valve, a second control valve, a third control valve, a fourth control valve, a fifth control valve, a sixth control valve, a first pressure sensor, and a second pressure sensor;
first connection ports a of the front offset unit control valve group, the rear offset unit control valve group, the tilting unit control valve group, the lifting unit control valve group, and the traveling unit control valve group are respectively connected to the first control valve and the fourth control valve; second connection ports b are respectively connected to the second control valve and the fifth control valve; third connection ports c are respectively connected to the third control valve and the sixth control valve; fourth connection ports d are respectively connected to the first control valve, the second control valve, the third control valve and the first pressure sensor; and fifth connection ports e are respectively connected to the fourth control valve, the fifth control valve, the sixth control valve, and the second pressure sensor.

Optionally, the front offset unit, the rear offset unit, the tilting unit and the lifting unit are configured to control a connection of two chambers of a corresponding actuator to a high-pressure accumulator, a medium-pressure accumulator, or an oil tank respectively based on pressure information of the two chambers of the corresponding actuator measured by a first pressure sensor and a second pressure sensor as well as motor torque information of a lead screw motor so as to complete pressure matching; where the lead screw motor performs pressure and torque compensation and motion control based on rotation angle/speed information of an motor encoder;
the traveling unit is configured to control a connection of an inlet and outlet of a corresponding traveling hydraulic motor to the high-pressure accumulator, the medium-pressure accumulator or the oil tank respectively based on pressure information of the inlet and outlet of the corresponding traveling hydraulic motor measured by the first pressure sensor and the second pressure sensor as well as motor torque information of a traveling drive motor so as to complete the pressure matching; where the traveling drive motor performs the pressure and torque compensation and motion control based on the rotation angle/speed information of the motor encoder.

The present disclosure also provides a method for controlling an electric-hydraulic integrated drive system for large-scale forging manipulators, based on the described system, including the following steps:
when the first front offset actuator, the second front offset actuator, the first rear offset actuator, the second rear offset actuator, the tilting actuator, the first lifting actuator, and the second lifting actuator, or the first traveling hydraulic motor and the second traveling hydraulic motor is in an overrunning condition, dynamic potential energy is converted into electrical energy through the lead screw drive motor, the traveling drive motor or the motor of the hydraulic power unit, and is directly converted for use or stored through the electrical drive unit, or the dynamic potential energy is directly stored in the high-pressure accumulator and the medium-pressure accumulator, or the dynamic potential energy is stored and used through a combination of the electrical drive unit, the high-pressure accumulator and the medium-pressure accumulator; and
when the first front offset actuator, the second front offset actuator, the first rear offset actuator, the second rear offset actuator, the tilting actuator, the first lifting actuator, and the second lifting actuator, or the first traveling hydraulic motor and the second traveling hydraulic motor is stationary, the two chambers of the first front offset actuator, the second front offset actuator, the first rear offset actuator, the second rear offset actuator or inlet and outlet sides of the first traveling hydraulic motor and the second traveling hydraulic motor are at a same pressure level; when movement is required, the pressure level of one side or both sides of the two chambers of the first front offset actuator, the second front offset actuator, the first rear offset actuator, the second rear offset actuator, the inlet and outlet of the first traveling hydraulic motor or the second traveling hydraulic motor is switched to perform system response.

Compared with the prior art, the disclosure has the following advantages and technical effects.

The electrical-hydraulic integrated drive system for large-scale forging manipulators proposed by the disclosure enables electromechanical control position/speed and angular position/rotational speed, while utilizing hydraulic control for force and torque. The system reduces throttling losses and exhibits fast response characteristics, and fully integrates the advantages of both technologies. Consequently, the installed power and costs are reduced. Through the coaxial integration of electric motors and hydraulic motors, the transmission efficiency is further improved.

The electrical-hydraulic integrated drive system for large-scale forging manipulators proposed by the disclosure realizes simultaneous control of position/speed-force and angular position/rotational speed-torque. This enables position and speed control to remain unaffected by inertia and external load disturbance, ensuring high control accuracy and superior control performance. The system is able to meet the requirements for both position/speed-force and angular position/speed-torque at the same time.

The electrical-hydraulic integrated drive system for large-scale forging manipulators proposed by the disclosure is able to connect to the pressure source when the actuator is stationary, and realize rapid response through pressure level switching when movement is required. This reduces pressure build-up time and further improves system response speed.

The electrical-hydraulic integrated drive system for large-scale forging manipulators proposed by the disclosure is able to realize efficient storage and utilization of dynamic potential energy under the overrunning condition of the actuator, efficient sharing of direct current (DC) bus energy, and flow sharing of multiple actuators, thereby improving system energy efficiency.

The electrical-hydraulic integrated drive system for large-scale forging manipulators proposed by the disclosure performs pressure and torque compensation and motion control based on the position/speed information converted from the motor encoder, or the rotation angle/speed information and motor torque information of the motor encoder. This eliminates the need for additional installation of displacement sensors and speed sensors, simplifies system information acquisition, and combines high power density, high energy efficiency and high performance, thereby laying the foundation for the intellectualization of forging manipulators.

### BRIEF DESCRIPTION OF THE DRAWINGS

The drawings, which form a part of this application, are intended to provide a further understanding of this application. The schematic embodiment and descriptions of this application are used to explain this application, and do not constitute an improper limitation of this application.

FIG. 1 is an external view of the large-scale forging manipulator according to an embodiment of the disclosure.

FIG. 2 is a mechanical structure diagram of the large-scale forging manipulator according to an embodiment of the disclosure.

FIG. 3 is a schematic diagram of the electrical-hydraulic integrated drive system for the large-scale forging manipulator according to an embodiment of the disclosure.

FIG. 4 is a schematic diagram of the control valve group according to an embodiment of the disclosure.

FIG. 5 is a control block diagram of the position/speed-force and angular position/speed-torque decoupling control method for the electrical-hydraulic integrated drive system for the large-scale forging manipulator according to an embodiment of the disclosure.

FIG. 6 is a control flow chart of the position/speed-force and angular position/speed-torque decoupling control for the electrical-hydraulic integrated drive system for the large-scale forging manipulator according to an embodiment of the disclosure.

### DETAILED DESCRIPTION OF THE EMBODIMENT

It should be noted that the embodiment in this application and the features in the embodiment may be combined with each other if no conflict arises. This application will be described in detail below with reference to the accompanying drawings and embodiment.

It should be noted that the steps illustrated in the flowchart of the drawings may be executed in a computer system such as a set of computer-executable instructions. Although logical sequences are shown in the flowchart, in some cases, the steps shown or described may be executed in an order different from here.

### Embodiment

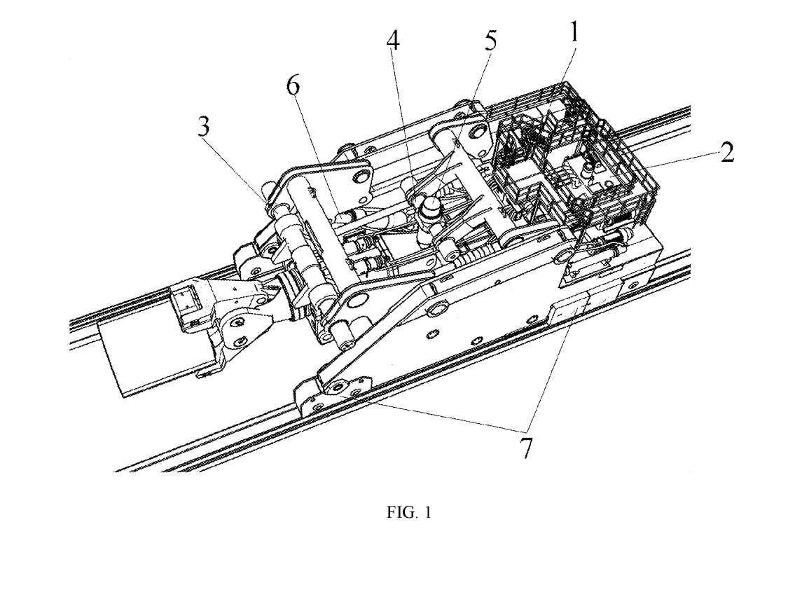

As shown in FIG. 1, the embodiment provides an electric-hydraulic integrated drive system for large-scale forging manipulators, including: an electrical drive unit 1, a hydraulic power unit 2, a front offset unit 3, a rear offset unit 4, a tilting unit 5, a lifting unit 6 and a traveling unit 7.

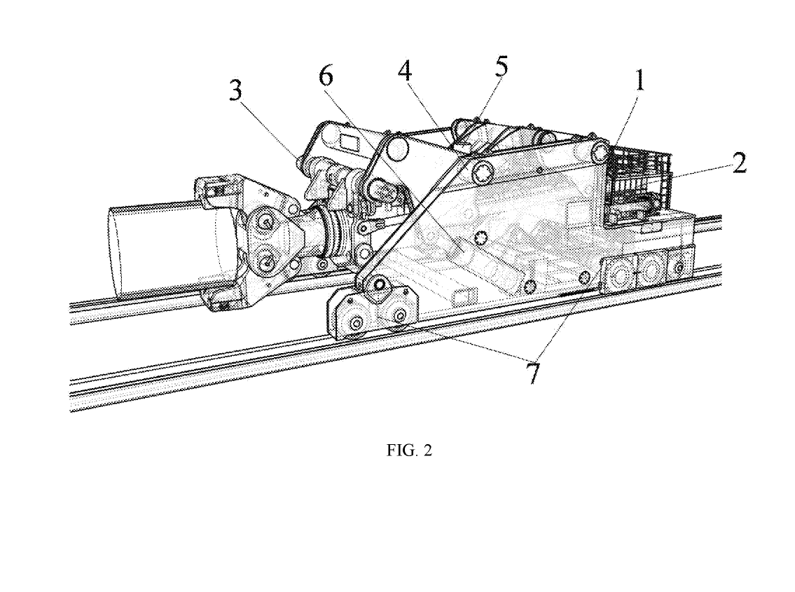

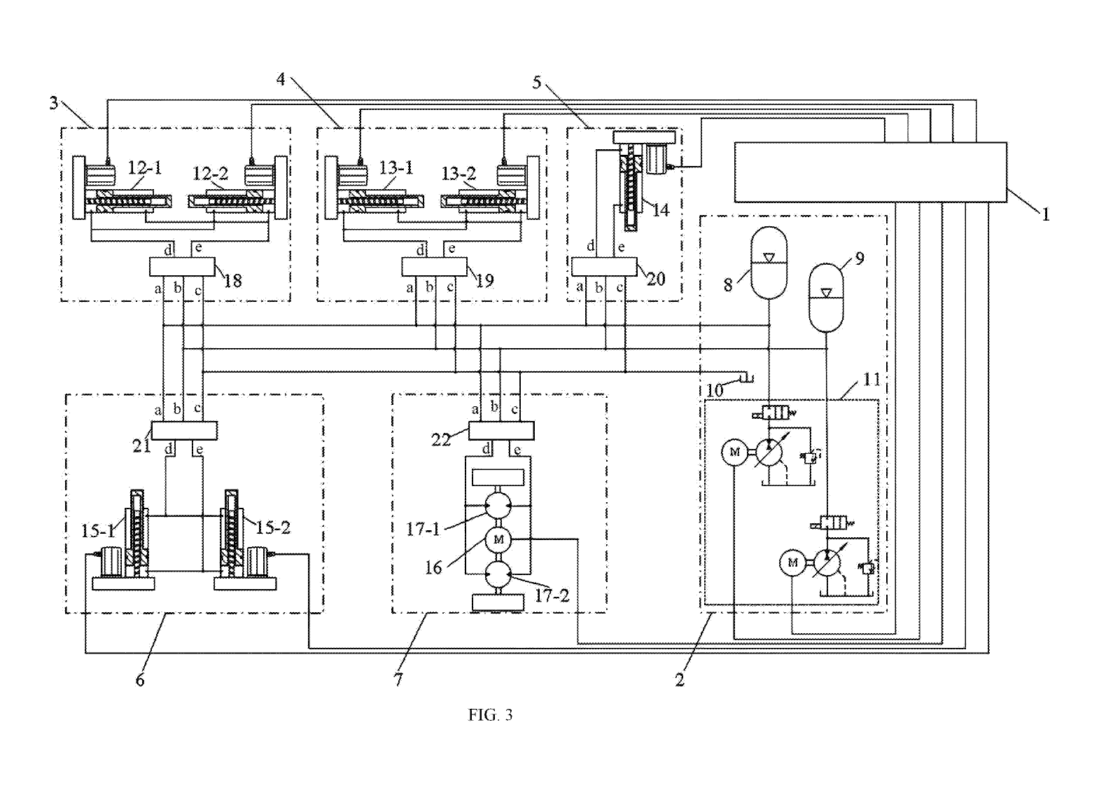

As shown in FIGS. 2 and FIG. 3, the electrical drive unit 1 is connected to an external power grid on one hand, and is respectively connected to motors of the hydraulic power unit, the front offset unit 3, the rear offset unit 4, the tilting unit 5, the lifting unit 6, and the traveling unit 7 on the other hand;
the hydraulic power unit 2 is respectively connected to control valve groups of the front offset unit 3, the rear offset unit 4, the tilting unit 5, the lifting unit 6, and the traveling unit 7.

The hydraulic power unit 2 includes a high-pressure accumulator 8, a medium-pressure accumulator 9, an oil tank 10, and an oil supplement module 11; where the high-pressure accumulator 8, and the medium-pressure accumulator 9 are respectively connected to the oil supplement module 11.

The front offset unit 3 includes a first front offset actuator 12-1, a second front offset actuator 12-2, and a front offset unit control valve group 18; where the first front offset actuator 12-1 and the second front offset actuator 12-2 are arranged symmetrically; one end of the first front offset actuator 12-1 and the second front offset actuator 12-2 is installed on a front swing arm, and another end is connected to a suspension rod; a motor of the first front offset actuator 12-1 is connected to the electrical drive unit 1, and a motor of the second front offset actuator 12-2 is connected to the electrical drive unit 1; a first connection port a, a second connection port b, and a third connection port c of the front offset unit control valve group 18 are respectively connected to the high-pressure accumulator 8, the medium-pressure accumulator 9, and the oil tank 10; and a fourth connection port d and a fifth connection port e of the front offset unit control valve group 18 are respectively connected to a rodless chamber of the first front offset actuator 12-1, a rod chamber of the second front offset actuator 12-2, a rod chamber of the first front offset actuator 12-1, and a rodless chamber of the second front offset actuator 12-2;
the rear offset unit 4 includes a first rear offset actuator 13-1, a second rear offset actuator 13-2 and a rear offset unit control valve group 19; where the first rear offset actuator 13-1 and the second rear offset actuator 13-2 are arranged symmetrically; one end of the first rear offset actuator 13-1 and the second rear offset actuator 13-2 is installed on a rear swing arm, and another end is connected to a tilting unit actuator 14; a motor of the first rear offset actuator 13-1 is connected to the electrical drive unit 1, and a motor of the second rear offset actuator 13-2 is connected to the electrical drive unit 1; a first connection port a, a second connection port b, and a third connection port c of the rear offset unit control valve group 19 are respectively connected to the high-pressure accumulator 8, the medium-pressure accumulator 9, and the oil tank 10; and a fourth connection port d and a fifth connection port e of the rear offset unit control valve group 19 are respectively connected to a rodless chamber of the first rear offset actuator 13-1, a rod chamber of the second rear offset actuator 13-2, a rod chamber of the first rear offset actuator 13-1, and a rodless chamber of the second rear offset actuator 13-2;
the tilting unit 5 includes a tilting actuator 14 and a tilting unit control valve group 20; where one end of the tilting actuator 14 is connected to a rear offset unit actuator, and another end is connected to a clamp frame; the motor of the tilting actuator 14 is connected to the electrical drive unit 1; a first connection port a, a second connection port b and a third connection port c of the tilting unit control valve group 20 are respectively connected to the high-pressure accumulator 8, the medium-pressure accumulator 9 and the oil tank 10; and a fourth connection port d and a fifth connection port e of the tilting unit control valve group 20 are respectively connected to a rodless chamber and a rod chamber of the tilting actuator 14;
the lifting unit 6 includes a first lifting actuator 15-1, a second lifting actuator 15-2 and a lifting unit control valve group 21; the first lifting actuator 15-1 and the second lifting actuator 15-2 are arranged symmetrically; one end of the first lifting actuator 15-1 and the second lifting actuator 15-2 is installed on a cart, and another end is connected to the front swing arm; a motor of the first lifting actuator 15-1 is connected to the electrical drive unit 1, and a motor of the second lifting actuator 15-2 is connected to the electrical drive unit 1; a first connection port a, a second connection port b, and a third connection port c of the lifting unit control valve group 21 are respectively connected to the high-pressure accumulator 8, the medium-pressure accumulator 9 and the oil tank 10; and a fourth connection port d and a fifth connection port e of the lifting unit control valve group 21 are respectively connected to a rod chamber of the first lifting actuator 15-1, a rod chamber of the second lifting actuator 15-2, a rodless chamber of the first lifting actuator 15-1, and a rodless chamber of the second lifting actuator 15-2; and
the traveling unit 7 includes a traveling drive motor 16, a first traveling hydraulic motor 17-1, a second traveling hydraulic motor 17-2 and a traveling unit control valve group 22; the traveling unit 7 is installed on the cart and connected to wheels; the traveling drive motor 16 is connected to the electrical drive unit 1; a first connection port a, a second connection port b, and a third connection port c of the traveling unit control valve group 22 are respectively connected to the high-pressure accumulator 8, the medium-pressure accumulator 9 and the oil tank 10; and a fourth connection port d and a fifth connection port e of the traveling unit control valve group 22 are respectively connected to an inlet of the first traveling hydraulic motor 17-1, an inlet of the second traveling hydraulic motor 17-2, an outlet of the first traveling hydraulic motor 17-1, and an outlet of the second traveling hydraulic motor 17-2.

The traveling unit 7 selects any one form of front-wheel drive, rear-wheel drive and front-rear wheel common drive according to actual requirements; and a drive form of each wheel is traveling drive motor 16 drive, traveling hydraulic motor drive or common drive of traveling drive motor 16 and traveling hydraulic motor; where the traveling hydraulic motor includes the first traveling hydraulic motor 17-1 and the second traveling hydraulic motor 17-2.

The drive form of the traveling drive motor 16, the first traveling hydraulic motor 17-1 and the second traveling hydraulic motor 17-2 for the traveling unit adopts any one form of coaxial series connection, multi-axis parallel connection or coaxial integration;
the numbers of the traveling drive motor 16, the first traveling hydraulic motor 17-1, and the third traveling hydraulic motor 17-2 are configured according to actual requirements.

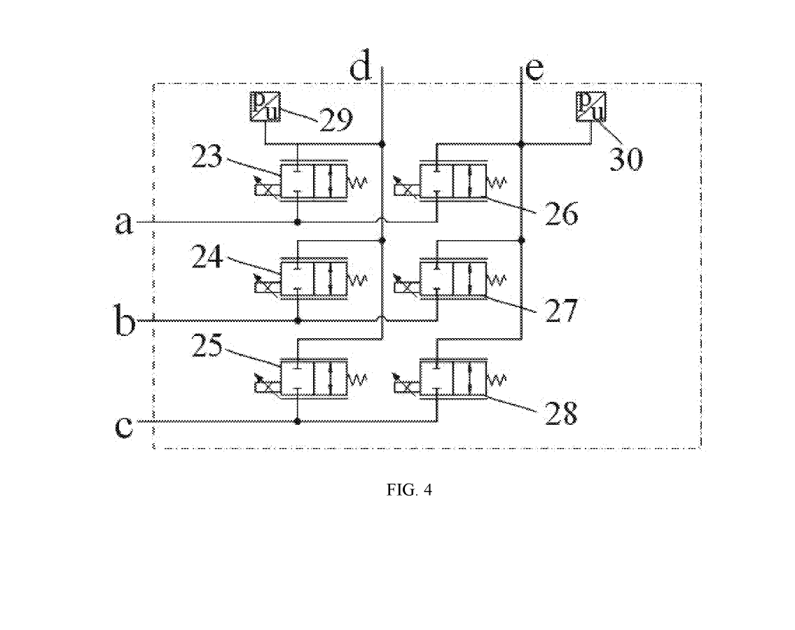

As shown in FIG. 4, the front offset unit control valve group 18, the rear offset unit control valve group 19, the tilting unit control valve group 20, the lifting unit control valve group 21, and the traveling unit control valve group 22 all include a first control valve 23, a second control valve 24, a third control valve 25, a fourth control valve 26, a fifth control valve 27, a sixth control valve 28, a first pressure sensor 29, and a second pressure sensor 30; characterized in that: first connection port a of the control valve group is connected to the first control valve 23 and the fourth control valve 26; second connection port b of the control valve group is connected to the second control valve 24, and the fifth control valve 27; third connection port c of the control valve group is connected to the third control valve 25, and the sixth control valve 28; fourth connection port d of the control valve group is connected to the first control valve 23, the second control valve 24, the third control valve 25, and the first pressure sensor 29; the fifth connection port e of the control valve group is connected to the fourth control valve 26, the fifth control valve 27, the sixth control valve 28, and the second pressure sensor 30.

Further, the control valve is one of an on-off valve and a proportional valve.

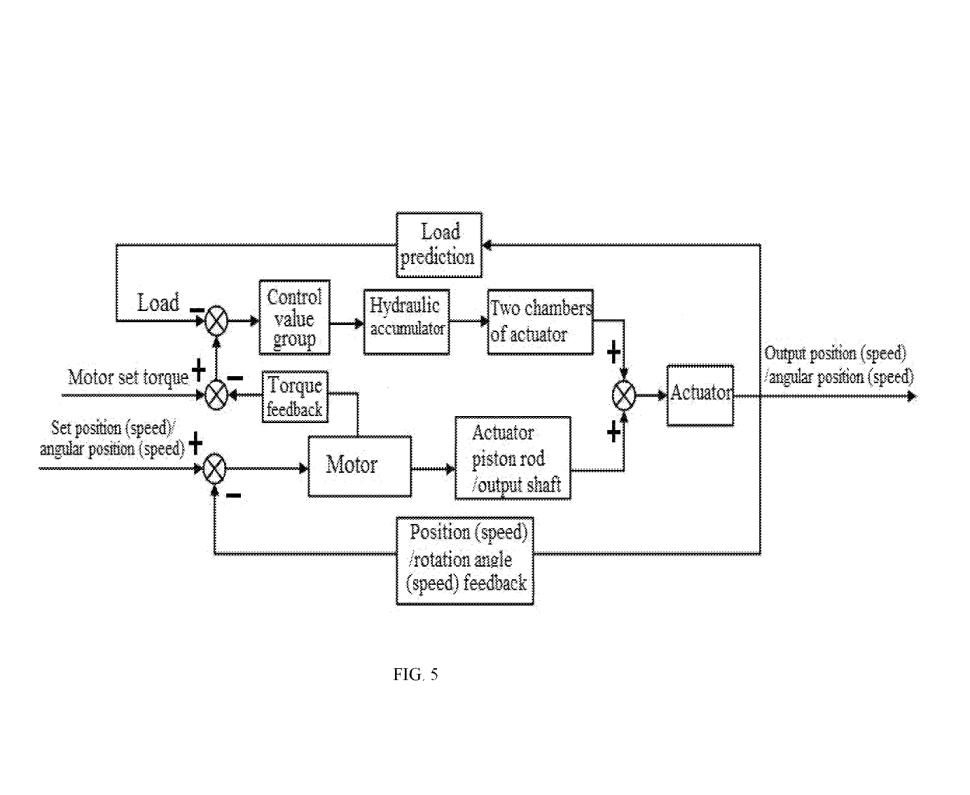

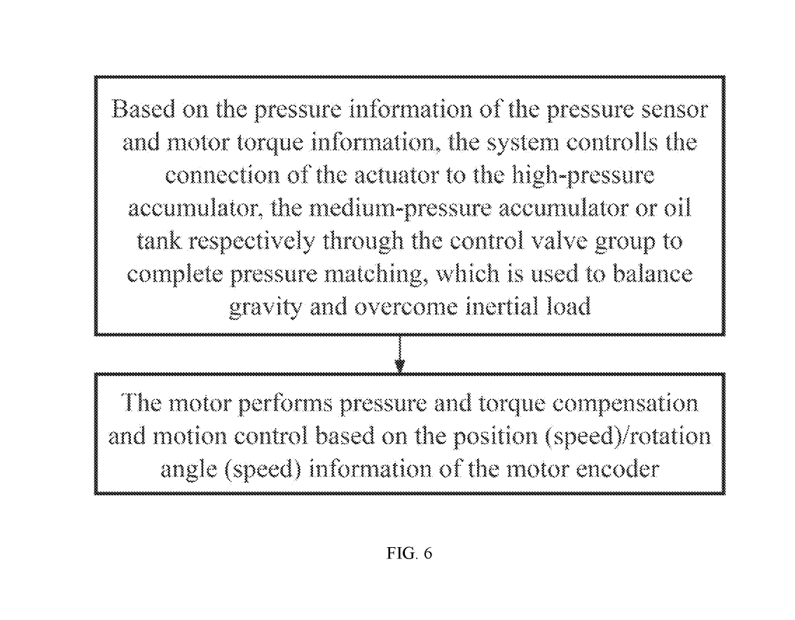

As shown in FIGS. 5 and FIG. 6, the front offset unit 3, the rear offset unit 4, the tilting unit 5, and the lifting unit 6 control a connection of two chambers of the actuator to the high-pressure accumulator 8, the medium-pressure accumulator 9, or the oil tank 10 respectively through the control valve group based on pressure information of the two chambers of the actuator measured by the first pressure sensor 29, and the second pressure sensor 30 as well as motor torque information of the lead screw motor so as to complete pressure matching; the lead screw drive motor performs pressure and torque compensation and motion control according to the rotation angle/speed information of the motor encoder, without additional installation of displacement sensors and speed sensors.

The traveling unit 7 controls the connection of the inlet and outlet of the traveling hydraulic motor to the high-pressure accumulator 8, the medium-pressure accumulator 9, or the oil tank 10 respectively through the control valve group based on the pressure information of the inlet and outlet of the traveling hydraulic motor measured by the first pressure sensor 29 and the second pressure sensor 30, and the motor torque information of the traveling drive motor 16, so as to complete pressure matching; and the traveling drive motor 16 performs pressure and torque compensation and motion control according to the rotation angle/speed information of the motor encoder, without additional installation of angular displacement sensors and speed sensors.

The oil supplement module 11 is configured to supplement oil to the high-pressure accumulator 8 and the medium-pressure accumulator 9 when the measured pressure of the high-pressure accumulator 8 and the medium-pressure accumulator 9 is lower than the set pressure.

The embodiment also provides a method based for an electric-hydraulic integrated drive system for large-scale forging manipulators, based on the above system, including the following steps:
when the first front offset actuator 12-1, the second front offset actuator 12-2, the first rear offset actuator 13-1, the second rear offset actuator 13-2, the tilting actuator 14, the first lifting actuator 15-1, and the second lifting actuator 15-2, or the first traveling hydraulic motor 17-1 and the second traveling hydraulic motor 17-2 is in an overrunning condition, dynamic potential energy is converted into electrical energy through the lead screw drive motor, the traveling drive motor 16 or the motor of the hydraulic power unit 2, and is directly converted for use or stored through the electrical drive unit 1, or the dynamic potential energy is directly stored in the high-pressure accumulator 8 and the medium-pressure accumulator 9; or the dynamic potential energy is stored and used through a combination of the electrical drive unit 1, the high-pressure accumulator 8, and the medium-pressure accumulator 9.

The drive chambers of the first front offset actuator 12-1, the second front offset actuator 12-2, the first rear offset actuator 13-1, and the second rear offset actuator 13-2 of the front offset unit 3 and the rear offset unit 4 are symmetrically arranged and horizontally placed without being affected by gravity; the inlets and outlets of the first traveling hydraulic motor 17-1 and the second traveling hydraulic motor 17-2 of the traveling unit 7 are symmetrical.

When the first front offset actuator 12-1, the second front offset actuator 12-2, the first rear offset actuator 13-1, and the second rear offset actuator 13-2, or the first traveling hydraulic motor 17-1 and the second traveling hydraulic motor 17-2 is stationary, the two chambers of the first front offset actuator 12-1, the second front offset actuator 12-2, the first rear offset actuator 13-1, the second rear offset actuator 13-2 or inlet and outlet sides of the first traveling hydraulic motor 17-1 and the second traveling hydraulic motor 17-2 are at the same pressure level; when movement is required, the pressure level of one side or both sides of the two chambers of the first front offset actuator 12-1, the second front offset actuator 12-2, the first rear offset actuator 13-1, and the second rear offset actuator 13-2, or the inlet and outlet of the first traveling hydraulic motor 17-1 and the second traveling hydraulic motor 17-2 is switched, which reduces pressure build-up time and further improves system response speed.

The control method provided in the embodiment utilizes electromechanical systems for position/speed and angular position/rotational speed control, while employing hydraulic systems for force and torque regulation. Through pressure-level switching, it achieves rapid response and enables simultaneous control of both position/speed-force and angular position/rotational speed-torque, fully integrates the advantages of both electrical and hydraulic technologies. The accumulators deliver multi-stage pressure to meet peak power demands, counterbalance gravitational forces and overcome inertial loads. The electric motor is employed for pressure and torque compensation as well as motion control, ensuring that position and speed regulation remain unaffected by inertial and external load disturbances. The system offers fast response speed, high control accuracy, low energy consumption, reduced installed power and cost efficiency. Moreover, it features easy access to system information, high power density, high energy efficiency, and superior performance, laying a solid foundation for the intelligentization of forging manipulators.

The above is only an optional specific implementation mode of the application, but the protection scope of the application is not limited to this; any person skilled in the technical field may easily think of changes or substitutions within the technical scope disclosed in the application, and all should be covered within the protection scope of the application. Therefore, the protection scope of the application should be subject to the protection scope of the claims.

What is claimed is:

1. An electric-hydraulic integrated drive system for large-scale forging manipulators, comprising: an electrical drive unit, a hydraulic power unit, a front offset unit, a rear offset unit, a tilting unit, a lifting unit, and a traveling unit; wherein
the electrical drive unit is connected to an external power grid on one hand, and is respectively connected to motors of the hydraulic power unit, the front offset unit, the rear offset unit, the tilting unit, the lifting unit, and the traveling unit on the other hand;
the hydraulic power unit is respectively connected to control valve groups of the front offset unit, the rear offset unit, the tilting unit, the lifting unit, and the traveling unit;
the front offset unit, the rear offset unit, the tilting unit, and the lifting unit are configured to control a connection of two chambers of a corresponding actuator to a high-pressure accumulator, a medium-pressure accumulator or an oil tank respectively based on pressure information of the two chambers of the corresponding actuator measured by a first pressure sensor and a second pressure sensor as well as motor torque information of a lead screw motor so as to complete pressure matching; wherein the lead screw motor performs pressure and torque compensation and motion control based on rotation angle/speed information of an motor encoder; and
the traveling unit is configured to control a connection of an inlet and outlet of a corresponding traveling hydraulic motor to the high-pressure accumulator, the medium-pressure accumulator or the oil tank respectively based on pressure information of the inlet and outlet of the corresponding traveling hydraulic motor measured by the first pressure sensor and the second pressure sensor as well as motor torque information of a traveling drive motor so as to complete the pressure matching; wherein the traveling drive motor performs the pressure and torque compensation and motion control based on the rotation angle/speed information of the motor encoder.

2. The system according to claim 1, wherein the hydraulic power unit comprises the high-pressure accumulator, the medium-pressure accumulator, the oil tank, and an oil supplement module; wherein the high-pressure accumulator and the medium-pressure accumulator are respectively connected to the oil supplement module.

3. The system according to claim 1, wherein the front offset unit comprises a first front offset actuator, a second front offset actuator, and a front offset unit control valve group; wherein the first front offset actuator and the second front offset actuator are arranged symmetrically; one end of the first front offset actuator and the second front offset actuator is installed on a front swing arm, and another end is connected to a suspension rod; a motor of the first front offset actuator is connected to the electrical drive unit, and a motor of the second front offset actuator is connected to the electrical drive unit; a first connection port a, a second connection port b, and a third connection port c of the front offset unit control valve group are respectively connected to the high-pressure accumulator, the medium-pressure accumulator and the oil tank; and a fourth connection port d and a fifth connection port e of the front offset unit control valve group are respectively connected to a rodless chamber of the first front offset actuator, a rod chamber of the second front offset actuator, a rod chamber of the first front offset actuator, and a rodless chamber of the second front offset actuator;
the rear offset unit comprises a first rear offset actuator, a second rear offset actuator, and a rear offset unit control valve group; wherein the first rear offset actuator and the second rear offset actuator are arranged symmetrically; one end of the first rear offset actuator and the second rear offset actuator is installed on a rear swing arm, and another end is connected to a tilting unit actuator; a motor of the first rear offset actuator is connected to the electrical drive unit, and a motor of the second rear offset actuator is connected to the electrical drive unit; a first connection port a, a second connection port b, and a third connection port c of the rear offset unit control valve group are respectively connected to the high-pressure accumulator, the medium-pressure accumulator, and the oil tank; and a fourth connection port d and a fifth connection port e of the rear offset unit control valve group are respectively connected to a rodless chamber of the first rear offset actuator, a rod chamber of the second rear offset actuator, a rod chamber of the first rear offset actuator, and a rodless chamber of the second rear offset actuator;
the tilting unit comprises a tilting actuator and a tilting unit control valve group; wherein one end of the tilting actuator is connected to a rear offset unit actuator, and another end is connected to a clamp frame; a motor of the tilting actuator is connected to the electrical drive unit; a first connection port a, a second connection port b, and a third connection port c of the tilting unit control valve group are respectively connected to the high-pressure accumulator, the medium-pressure accumulator, and the oil tank; and a fourth connection port d and a fifth connection port e of the tilting unit control valve group are respectively connected to a rodless chamber, and a rod chamber of the tilting actuator;
the lifting unit comprises a first lifting actuator, a second lifting actuator, and a lifting unit control valve group; the first lifting actuator and the second lifting actuator are arranged symmetrically; one end of the first lifting actuator and the second lifting actuator is installed on a cart, and another end is connected to the front swing arm; a motor of the first lifting actuator is connected to the electrical drive unit, and a motor of the second lifting actuator is connected to the electrical drive unit; a first connection port a, a second connection port b, and a third connection port c of the lifting unit control valve group are respectively connected to the high-pressure accumulator, the medium-pressure accumulator, and the oil tank; and a fourth connection port d and a fifth connection port e of the lifting unit control valve group are respectively connected to a rod chamber of the first lifting actuator, a rod chamber of the second lifting actuator, a rodless chamber of the first lifting actuator, and a rodless chamber of the second lifting actuator; and
the traveling unit comprises a traveling drive motor, a first traveling hydraulic motor, a second traveling hydraulic motor, and a traveling unit control valve group; the traveling unit is installed on the cart and connected to wheels; the traveling drive motor is connected to the electrical drive unit; a first connection port a, a second connection port b, and a third connection port c of the traveling unit control valve group are respectively connected to the high-pressure accumulator, the medium-pressure accumulator, and the oil tank; and a fourth connection port d and a fifth connection port e of the traveling unit control valve group are respectively connected to an inlet of the first traveling hydraulic motor, an inlet of the second traveling hydraulic motor, an outlet of the first traveling hydraulic motor, and an outlet of the second traveling hydraulic motor.

4. The system according to claim 3, wherein the traveling unit selects any one form of front-wheel drive, rear-wheel drive, and front-rear wheel common drive according to actual requirements; and a drive form of each wheel is traveling drive motor drive, traveling hydraulic motor drive or common drive of traveling drive motor and traveling hydraulic motor;
wherein the drive form of the traveling drive motor and traveling hydraulic motor for the traveling unit adopts any one form of coaxial series connection, multi-axis parallel connection or coaxial integration; and
a number of the traveling drive motors and the traveling hydraulic motors is configured according to actual requirements.

5. The system according to claim 3, wherein the first front offset actuator, the second front offset actuator, the first rear offset actuator, the second rear offset actuator, the tilting actuator, the first lifting actuator, and the second lifting actuator all comprise the lead screw drive motor, a reducer, a lead screw pair, a seal, a cylinder block and a piston rod;
wherein the lead screw drive motor converts rotational motion into linear motion of the piston rod sequentially through the reducer and the lead screw pair; and
the hydraulic power unit drives the piston rod to perform linear motion through the control valve group.

6. The system according to claim 3, wherein the front offset unit control valve group, the rear offset unit control valve group, the tilting unit control valve group, the lifting unit control valve group, and the traveling unit control valve group all comprise a first control valve, a second control valve, a third control valve, a fourth control valve, a fifth control valve, a sixth control valve, a first pressure sensor, and a second pressure sensor;
wherein first connection ports a of the front offset unit control valve group, the rear offset unit control valve group, the tilting unit control valve group, the lifting unit control valve group, and the traveling unit control valve group are respectively connected to the first control valve and the fourth control valve; second connection ports b are respectively connected to the second control valve and the fifth control valve; third connection ports c are respectively connected to the third control valve and the sixth control valve; the fourth connection ports d are respectively connected to the first control valve, the second control valve, the third control valve, and the first pressure sensor; and fifth connection ports e are respectively connected to the fourth control valve, the fifth control valve, the sixth control valve, and the second pressure sensor.

7. A method for controlling an electric-hydraulic integrated drive system for large-scale forging manipulators according to claim 1, comprising the following steps:
when the first front offset actuator, the second front offset actuator, the first rear offset actuator, the second rear offset actuator, the tilting actuator, the first lifting actuator, and the second lifting actuator, or the first traveling hydraulic motor and the second traveling hydraulic motor are in an overrunning condition, dynamic potential energy is converted into electrical energy through the lead screw drive motor, the traveling drive motor, or a motor of the hydraulic power unit, and is directly converted for use or stored through the electrical drive unit, or the dynamic potential energy is directly stored in the high-pressure accumulator and the medium-pressure accumulator, or the dynamic potential energy is stored and used through a combination of the electrical drive unit, the high-pressure accumulator and the medium-pressure accumulator; and
when the first front offset actuator, the second front offset actuator, the first rear offset actuator, the second rear offset actuator, the tilting actuator, the first lifting actuator, and the second lifting actuator, or the first traveling hydraulic motor and the second traveling hydraulic motor are stationary, two chambers of the first front offset actuator, the second front offset actuator, the first rear offset actuator, and the second rear offset actuator, or inlet and outlet sides of the first traveling hydraulic motor, and the second traveling hydraulic motor are at a same pressure level; when movement is required, pressure level of one side or both sides of the two chambers of the first front offset actuator, the second front offset actuator, the first rear offset actuator, and the second rear offset actuator, or the pressure level of one side or both sides of the inlet and outlet of the first traveling hydraulic motor, and the second traveling hydraulic motor is switched to perform system response.
